(19) United States
(12) Patent Application Publication
(10) Pub. No.: US 2013/0024025 A1
(43) Pub. Date: Jan. 24, 2013

(54) Autonomous Robot and A Positioning Method Thereof

(71) Applicant: Harry Chia-Hung HSU, Zhonghe City (TW)

(72) Inventor: Harry Chia-Hung HSU, Zhonghe City (TW)

(21) Appl. No.: 13/309,601

(22) Filed: Dec. 2, 2011

(30) Foreign Application Priority Data
Jul. 21, 2011 (TW) 100125864

(51) Int. Cl. B25J 9/16

(52) U.S. Cl. 700/259; 700/245; 901/1; 901/47

(57) ABSTRACT

An autonomous robot and a positioning method thereof are disclosed. The autonomous robot includes an environment information detection device, a map construction module, a setting module, a path planning module, and a driving module. The environment information detection device is for detecting environment information about an environment where the autonomous robot is situated. An environment map is constructed based on the environment information detected by the environment information detection device. The setting module is used for setting a working boundary on the environment map. The path planning module is for planning a moving path in a working zone and is electrically connected to the setting module. The driving module for driving the autonomous robot to move along the moving path is electrically connected to the path planning module.

### BACKGROUND OF THE INVENTION

1. Field of the Invention

The present invention relates to an autonomous robot and a positioning method; more specifically, it relates to an autonomous robot capable of performing a task within an assigned boundary.

2. Description of the Related Art

A cleaning robot is one of the commonly used autonomous robots. If users want to limit the area covered by the cleaning robot, it is necessary to place boundary markers on the ground in a working environment where the cleaning robot is situated in order to confine the cleaning robot to working within the working boundary. Another option is to place an infrared device on the ground, such as the Virtual Wall Lighthouse, to limit the working area of the cleaning robot with infrared beams emitted by the device. However, both the boundary markers and the infrared device are external devices, all of which have to be collocated with the cleaning robot. The abovementioned external devices occupy space in a working environment, which may negatively affect the aesthetics, especially in a household environment, and also increase the financial burden on the user.

A system and method for graphically arranging a robot's working space is disclosed in the prior art. The method employs a projector mounted on the ceiling to project a grid of the working zone in order to confine the cleaning robot within the area displayed on the grid. In this method, the working area of the cleaning robot can be restricted without employing boundary markers or infrared devices on the ground; however, the projector mounted on the ceiling is still an external device that has to be collocated with the cleaning robot.

As a result, there is a need for a new autonomous robot that can perform tasks within an assigned working area without any assistance from any external devices.

### SUMMARY OF THE INVENTION

It is an object of the present invention to provide an autonomous robot and a positioning method, in which the autonomous robot is capable of performing a task within an assigned boundary without any external auxiliary devices.

To achieve the abovementioned object, an autonomous robot and a positioning method are disclosed, wherein the autonomous robot is capable of performing an assigned task in a working zone delineated by a working boundary. The autonomous robot includes an environment information detection device, a map construction module, a setting module, a path planning module, and a driving module. The environment information detection device detects information on a working environment where the autonomous robot is situated. The map construction module, electrically connected to the environment information detection device, is used for constructing an environment map based on the working environment information. A setting module, electrically connected to the map construction module, is used for setting the working boundary on the environment map. A path planning module, electrically connected to the setting module, is used for planning a working path in the working zone delineated by the working boundary for the autonomous robot. A driving module, electrically connected to the path planning module, is used for driving the autonomous robot to move along the working path.

### BRIEF DESCRIPTION OF THE DRAWINGS

FIG. 1 illustrates the structure of one embodiment of an autonomous robot.

FIG. 2 is a schematic drawing of one embodiment of the display interface and an environment map of the present invention.

FIG. 3 is a schematic drawing of a usage state of one embodiment of the autonomous robot.

FIG. 4 is a schematic drawing illustrating the communication between one embodiment of the autonomous robot and an external electronic device.

FIG. 5 is a flowchart of the steps of the positioning method of the present invention.

### DETAILED DESCRIPTION OF THE PREFERRED EMBODIMENT

The advantages and innovative features of the invention will become more apparent from the following detailed descriptions when taken together with the accompanying drawings.

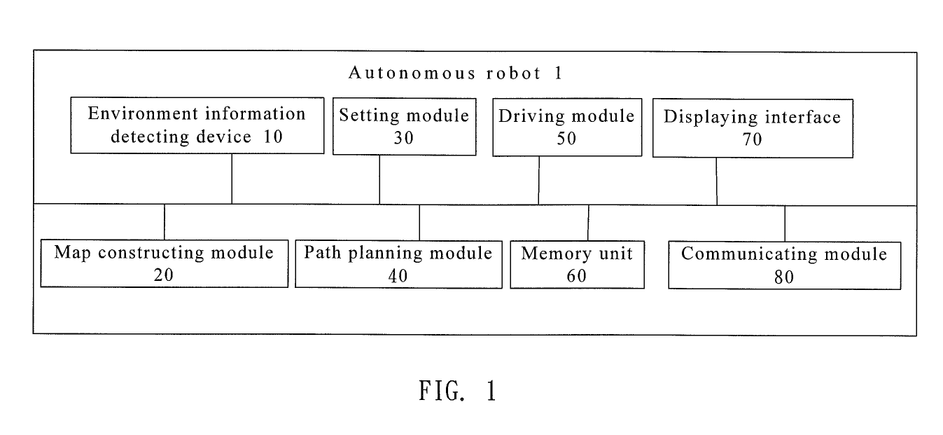

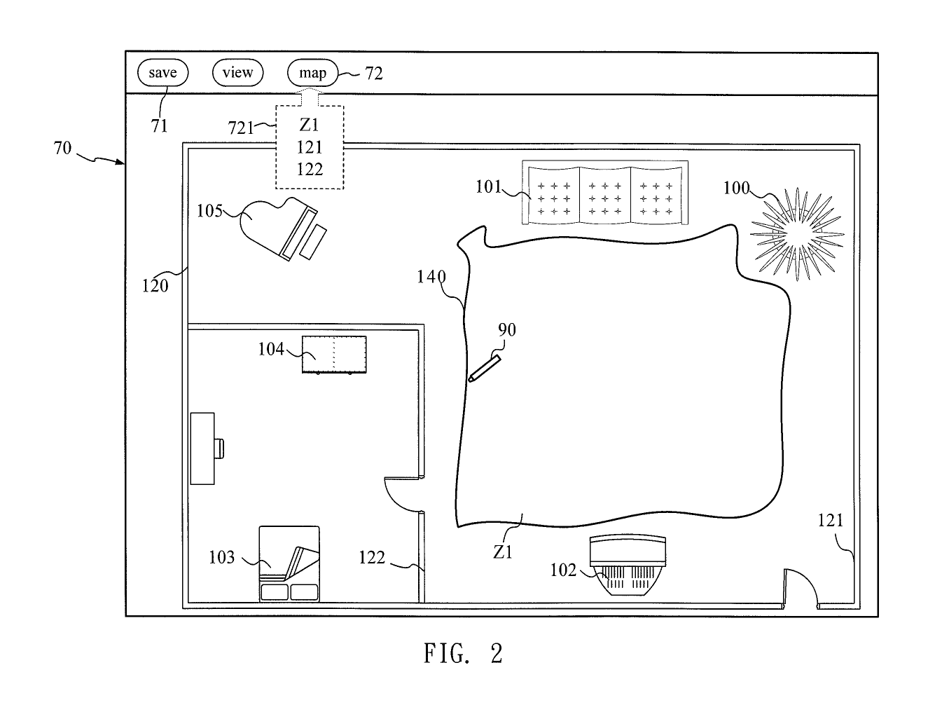

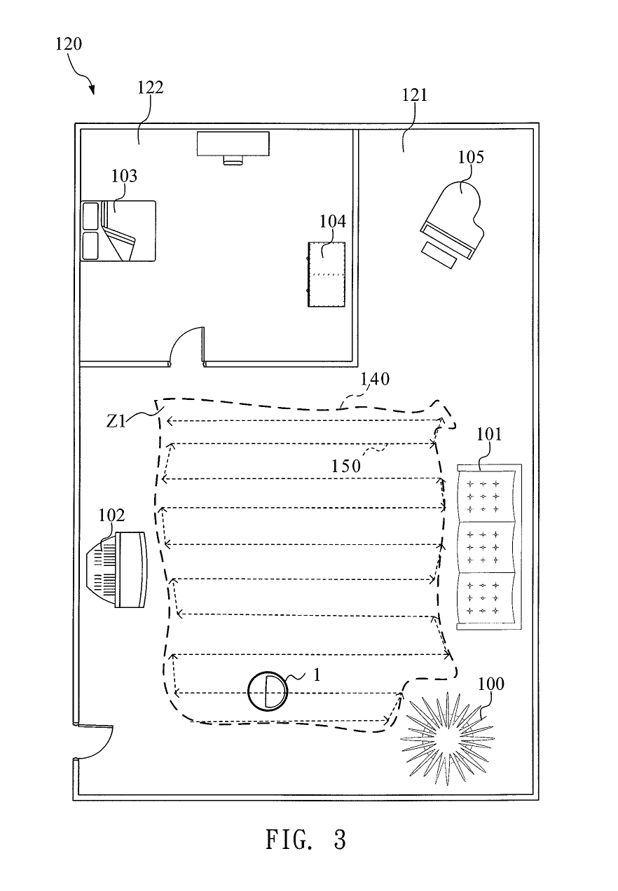

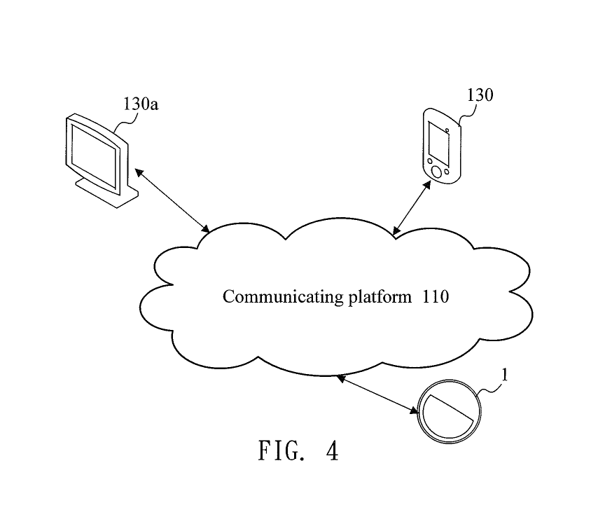

Please refer to FIG. 1 to FIG. 4 regarding an autonomous robot according to one embodiment of the present invention, wherein FIG. 1 illustrates the structure of one embodiment of an autonomous robot; FIG. 2 is a schematic drawing of one embodiment of the display interface and an environment map of the present invention; FIG. 3 is a schematic drawing of a usage state of one embodiment of the autonomous robot; and FIG. 4 is a schematic drawing illustrating the communication between one embodiment of the autonomous robot and an external electronic device.

The autonomous robot of the present invention is an autonomous device that is capable of performing an assigned task in a working zone. In one embodiment of the present invention, the autonomous robot of the present invention is, but is not limited to, a cleaning robot that is capable of performing a cleaning task within a working zone. The autonomous robot of the present invention can be an autonomous robot capable of performing other tasks, such as an automatic lawn mower or a floor washing robot.

As shown in FIG. 1, according to one embodiment of the present invention, the autonomous robot 1 of the present invention can perform an assigned task within a working zone that is delineated by a working boundary. The autonomous robot 1 includes an environment information detection device 10, a map construction module 20, a setting module 30, a path planning module 40, a driving module 50, a memory unit 60, a display interface 70, and a communication module 80. The environment information detection device 10 is used for detecting information on a working environment where the autonomous robot 1 is situated. The map construction module 20 is electrically connected to the environment information detection device 10 and used for constructing an environment map based on the working environment information that is detected by the environment information detection device 10. The setting module 30 is used for setting the working boundary on the environment map and is electrically connected to the map construction module 20. The path planning module 40, electrically connected to the setting module 30, is used for planning a working path in the working zone for the autonomous robot 1, and the working zone is delineated by the working boundary. The driving module 50 for driving the autonomous robot 1 to move along the working path is electrically connected to the path planning module 40. The memory unit 60 for storing the environment map, the working boundary, and the working zone is electrically connected to the setting module 30. The display interface 70 for displaying the environment map is electrically connected to the setting module 30. The communication module 80, for allowing the autonomous robot 1 to communicate with an external electronic device via an external communication platform, is electrically connected to the setting module 30. It is noted that all of the above-mentioned modules and devices can be hardware devices, software programs, firmware, electric circuit loops, or combinations of any of the above.

In one embodiment of the present invention, the working environment information refers to distances and bearings between the objects in the working environment and the autonomous robot 1 and is detected by the environment information detection device 10, by which positions of the objects related to the working environment information can be defined and an environment map can be constructed accordingly. Available devices for the environment information detection device 10 of the present invention are an infrared sensor, an ultrasonic range sensor, a laser sensor, or visual recognition devices such as a camera, a video camera, or the like. As shown in FIG. 2 and FIG. 3, the environment map 120 for displaying the objects' positions in the working environment is constructed by the map construction module 20 using the working environment information detected by the environment information detection device 10. In this embodiment, the environment map 120 is displayed on a display interface 70 (as shown in FIG. 2), and the display interface 70 is a screen disposed on the autonomous robot 1. The present invention is not limited to this embodiment; the display interface 70 can be a display screen of an external electronic device.

As shown in FIG. 2, it can be seen from one embodiment of the environment map 120 that the working environment where the autonomous robot 1 of the present invention is situated can be an indoor space with a living room 121 and a bedroom 122. Furniture items 100, 101, 102, 103, 104, and 105 are situated separately either in the living room 121 or in the bedroom 122. However, the working environment of the present invention is not limited to indoor spaces. After constructing the environment map 120, an input device 90 can be used by a user to assign a working boundary 140 on the environment map 120 on the display interface 70. The area that is delineated by the working boundary 140 is set as a working zone Z1 by the setting module 30. It is noted that the working boundary 140 is a virtual boundary that does not exist in the working environment. If users click on the store button 71 on the display interface 70, the environment map 120, including the living room 121, the bedroom 122, the working boundary 140, and the working zone Z1, can be stored in a memory unit 60. Therefore, users can choose the stored working zones such as the living room 121, bedroom 122, or working zone Z1 by clicking the map list 721 on the map button 72, or they can assign a new boundary. It is noted that the working zone of the autonomous robot 1 of the present invention is not limited to the virtual boundaries that are circled on the display interface 70 by users. The working zone of the autonomous robot 1 can also be a solid space; for instance, for the embodiment illustrated in FIG. 2, the working zone of the autonomous robot 1 can literally be the living room 121 or the bedroom 122. In addition, the input device 90 is a stylus, but the present invention is not limited to this embodiment. The available input device can be a mouse, a keyboard, or other kind of input device.

In this embodiment, the assigned working zone is the working zone Z1, which is delineated by the working boundary 140. The working path 150 within the working zone Z1 is planned by a path planning module 40 of the autonomous robot 1 based on the coverage of the working zone Z1. As shown in FIG. 3, the working path 150 is planned by the path planning module 40, and it is a Boustrophedon path in this embodiment. The autonomous robot 1 moves back and forth along the working path 150 within the working zone Z1 until an assigned task is completed. It is noted that the present invention is not limited to this embodiment; the working path 150 is only for illustration, and other path planning methods are applicable to the present invention as well. After the working path 150 within the working zone Z1 for the autonomous robot 1 has been planned, the autonomous robot 1 can move along the working path 150 within the working zone Z1 by the driving module 50. According to one embodiment of the present invention, the autonomous robot 1 moves along the working path 150 in the working zone Z1 until the cleaning task is completed; i.e., until the autonomous robot 1 has cleaned everywhere within the working zone Z1. In one embodiment of the present invention, the driving module 50 includes a pair of rolling wheels that drive the autonomous robot 1 to move. However, using rolling wheels as a driving method is only one embodiment of the autonomous robot 1 of the present invention, and the present invention is not limited to this embodiment. The moving directions and locations of the autonomous robot 1 of the present invention are controlled by Simultaneous Localization and Mapping (SLAM). Moreover, while the autonomous robot 1 is moving along the working path 150, real-time working environment information is detected by the environment information detection device 10 so that the autonomous robot 1 can avoid the working boundary 140 or other solid obstacles, such as furniture, thereby ensuring that the autonomous robot 1 will always stay within the working boundary 140 when performing a task (as shown in FIG. 3). While the autonomous robot 1 is moving along the working path 150, the environment map 120 is updated dynamically by the map construction module 20 based on the real-time working environment information detected by the environment information detection device 10 to increase the accuracy of the environment map 120. As a result, no external boundary markers or infrared devices for delineating the working zone of the autonomous robot 1 of the present invention are needed. It is noted that, because SLAM is a well-developed technology in the academic field and related industrial fields, the details of the methodology and operation of SLAM are omitted.

As mentioned before, the display interface 70 is not limited to the display screen on the autonomous robot 1. The display interface 70 can be a display screen of an external electronic device 130 or an electronic device 130a. As shown in FIG. 4, the environment map 120 can be transmitted to the display screen on an external electronic device 130 or an electronic device 130a by the communication module 80 of the autonomous robot 1 via a communication platform 110 such that users can set a working boundary for the autonomous robot 1 on the display screen on the electronic device 130 or electronic device 130a. Furthermore, by using the design of the communication module 80, the autonomous robot 1 of the present invention can be controlled remotely such that users can assign a working zone for the autonomous robot 1 or control the autonomous robot 1 through the electronic device 130 or electronic device 130a via the communication platform 110. It is noted that in one embodiment, the communication platform 110 of the present invention is a computer network and the electronic device 130 is a personal digital assistant (PDA), and the electronic device 130a is a personal computer. However, the present invention is not limited to the above-mentioned embodiments, and any electronic device with a display screen can be used for this purpose.

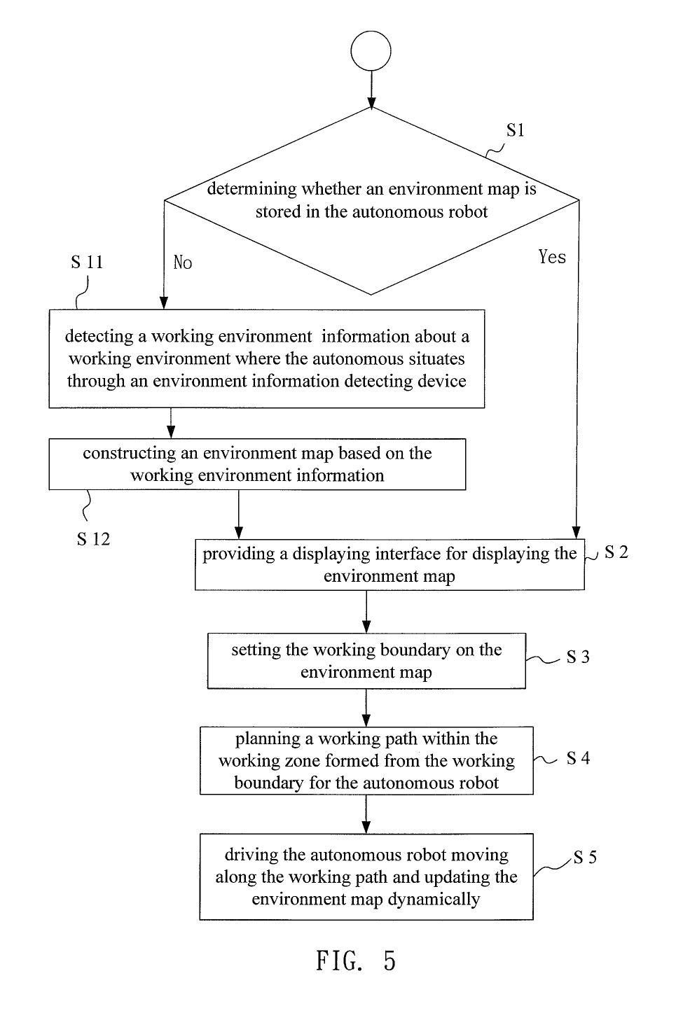

Please refer to FIG. 5. FIG. 5 is a flowchart of the steps of the positioning method of the present invention. The positioning method of the present invention can be applied to the autonomous robot 1, in which the autonomous robot 1 can perform an assigned task within a working zone formed by a working boundary. Please refer to FIG. 1 to FIG. 4 for illustration. In this embodiment, the autonomous robot 1 is a cleaning robot that performs a cleaning task within the working zone Z1 that is delineated by the working boundary 140. It is noted that the positioning method of the present invention is not limited to the above-mentioned drawings. The positioning method of the present invention comprises the following steps:

Step S1: determining whether an environment map 120 is stored in the autonomous robot 1.

If the environment map 120 is stored in the memory unit 60, implementing Step S2.

If the environment map 120 is not stored in the memory unit 60, implementing Step S11.

If the autonomous robot 1 of the present invention has been used or has performed a task in an environment, a corresponding environment map 120 is stored in the memory unit 60 and is available for use (as shown in FIG. 2).

Step S2: providing a display interface 70 for displaying the environment map 120.

The environment map 120 is displayed on the display interface 70, and the display interface 70 can be disposed on the autonomous robot 1 or displayed on the display screen of an external electronic device 130 or electronic device 130a. If the environment map 120 is displayed on the display screen of an external electronic device 130 or electronic device 130a, a communication platform 110 is needed for allowing the external electronic device 130 or electronic device 130a to communicate with the autonomous robot 1 (as shown in FIG. 4).

Step S3: setting the working boundary 140 on the environment map 120.

As shown in FIG. 2, users set a working boundary 140 on the environment map 120. At this point, the area delineated by the working boundary 140 is set as the working zone Z1 by the setting module 30.

Step S4: planning a working path 140 in the working zone Z1 delineated by the working boundary 150 for the autonomous robot 1.

As shown in FIG. 3, the working path 150 of the autonomous robot 1 in the working zone Z1 is planned by the planning module 40 based on the coverage of the working zone Z1. The path planning method applied in this embodiment is a Boustrophedon path. The Boustrophedon path allows the autonomous robot 1 to move back and forth in the working zone Z1 until an assigned task is completed. However, the present invention is not limited to this embodiment; any path planning methods are applicable.

Step S5: driving the autonomous robot 1 to move along the working path and dynamically updating the environment map.

As shown in FIG. 5, the autonomous robot 1 is driven by the driving module 50 such that the autonomous robot 1 moves within the working zone Z1 according to the working path 150 to perform an assigned task. Moreover, because the moving direction and the location of the autonomous robot 1 of the present invention are controlled by Simultaneous Localization and Mapping (SLAM), the environment map 120 can be dynamically updated by the map construction module 20 based on the real-time working environment information detected by the environment information detection device 10 while the autonomous robot 1 is moving along the working path 150 to increase the accuracy of the environment map 120.

Step S11: detecting working environment information about a working environment where the autonomous robot 1 is situated through an environment information detection device 10.

If it is the first time that the autonomous robot 1 of the present invention is used in a working environment, such that no corresponding environment map 120 is stored in the memory unit 60, it is necessary for the autonomous robot 1 to obtain an environment map 120 in order to facilitate cleaning procedures. The method for obtaining the environment map 120 is to use the environment information detection device 10 and SLAM to detect the working environment information, i.e., the distances and the bearings between the autonomous robot 1 and objects in the working environment.

Step S12: constructing an environment map 120 based on the working environment information.

The environment map 120 is constructed by the map construction module 20 based on the working environment information detected by the environment information detection device 10. After construction of the environment map 120, Step S2˜Step S5 are implemented. Step S2˜Step S5 are repeated steps, so details of each step are omitted; please refer to the paragraphs related to Step S2˜Step S5.

It is noted that the steps of the positioning method of the present invention are not restricted to the abovementioned order. As long as the objects of the present invention can be achieved, the above-mentioned order can be modified.

It must be noted that the above-mentioned embodiments are only for illustration. It is intended that the present invention cover modifications and variations of this invention provided that they fall within the scope of the following claims and their equivalents. Therefore, it will be apparent to those skilled in the art that various modifications can be made to the structure of the present invention without departing from the scope or spirit of the invention.

What is claimed is:

1. An autonomous robot capable of performing an assigned task in a working zone delineated by a working boundary comprising:
an environment information detection device for detecting working environment information about a working environment where the autonomous robot is situated;
a map construction module, electrically connected to the environment information detection device, for constructing an environment map based on the working environment information;
a setting module, electrically connected to the map construction module, for setting the working boundary on the environment map;
a path planning module, electrically connected to the setting module, for planning a working path in the working zone delineated by the working boundary for the autonomous robot; and
a driving module, electrically connected to the path planning module, for driving the autonomous robot to move along the working path.

2. The autonomous robot as claimed in claim 1, wherein the environment information detection device can be an infrared sensor, an ultrasonic range sensor, a laser sensor, a camera, or a video camera.

3. The autonomous robot as claimed in claim 2, wherein while the autonomous robot is moving along the working path, the environment map is dynamically updated by the map construction module based on real-time working environment information detected by the environment information detection device.

4. The autonomous robot as claimed in claim 1, wherein the autonomous robot comprises a memory unit, electrically connected to the setting module, for storing the environment map, the working boundary, and the working zone.

5. The autonomous robot as claimed in claim 4, wherein the environment information detection device can be an infrared sensor, an ultrasonic range sensor, a laser sensor, a camera, or a video camera.

6. The autonomous robot as claimed in claim 5, wherein while the autonomous robot is moving along the working path, the environment map is dynamically updated by the map construction module based on real-time working environment information detected by the environment information detection device.

7. The autonomous robot as claimed in claim 4, wherein the autonomous robot comprises a display interface, electrically connected to the setting module, for displaying the environment map.

8. The autonomous robot as claimed in claim 7, wherein the environment information detection device can be an infrared sensor, an ultrasonic range sensor, a laser sensor, a camera, or a video camera.

9. The autonomous robot as claimed in claim 8, wherein while the autonomous robot is moving along the working path, the environment map is dynamically updated by the map construction module based on real-time working environment information detected by the environment information detection device.

10. The autonomous robot as claimed in claim 7, wherein the autonomous robot comprises a communication module, electrically connected to the setting module, for communicating with an external electronic device via an external communication platform.

11. The autonomous robot as claimed in claim 10, wherein the environment information detection device can be an infrared sensor, an ultrasonic range sensor, a laser sensor, a camera, or a video camera.

12. The autonomous robot as claimed in claim 11, wherein while the autonomous robot is moving along the working path, the environment map is dynamically updated by the map construction module based on real-time working environment information detected by the environment information detection device.

13. The autonomous robot as claimed in claim 10, wherein the working path is a Boustrophedon path.

14. The autonomous robot as claimed in claim 13, wherein the environment information detection device can be an infrared sensor, an ultrasonic range sensor, a laser sensor, a camera, or a video camera.

15. The autonomous robot as claimed in claim 14, wherein while the autonomous robot is moving along the working path, the environment map is dynamically updated by the map construction module based on real-time working environment information detected by the environment information detection device.

16. A positioning method that can be applied to an autonomous robot for allowing the autonomous robot to perform an assigned task in a working zone delineated by a working boundary comprising the following steps:
determining whether an environment map is stored in the autonomous robot;
providing a display interface for displaying the environment map;
setting the working boundary on the environment map;
planning a working path in the working zone delineated by the working boundary for the autonomous robot; and
driving the autonomous robot to move along the working path and dynamically updating the environment map based on real-time working environment information detected by the environment information detection device.

17. The positioning method as claimed in claim 16, wherein the environment map is constructed using simultaneous localization and mapping (SLAM).

18. The positioning method as claimed in claim 16, wherein if the environment map is not stored in the autonomous robot, the method implements the following steps:
detecting working environment information about a working environment where the autonomous robot is situated through an environment information detection device; and
constructing an environment map based on the working environment information.

19. The positioning method as claimed in claim 18, wherein the environment map is constructed using simultaneous localization and mapping (SLAM).

20. A cleaning robot capable of performing a cleaning task in a working zone delineated by a working boundary comprising:
an environment information detection device for detecting working environment information about a working environment where the cleaning robot is situated;
a map construction module for constructing an environment map based on the working environment information;
a setting module, electrically connected to the map construction module, for setting the working boundary on the environment map;
a path planning module, electrically connected to the setting module, for planning a working path in the working zone delineated by the working boundary for the cleaning robot;
a driving module, electrically connected to the path planning module, for driving the cleaning robot to move along the working path;
a memory unit, electrically connected to the setting module, for storing the environment map, the working boundary, and the working zone;
a display interface, electrically connected to the setting module, for displaying the environment map; and
a communication module, electrically connected to the setting module, for communicating with an external electronic device via an external communication platform.
